(19) United States
(12) Patent Application Publication
(10) Pub. No.: US 2015/0298248 A1
(43) Pub. Date: Oct. 22, 2015

(54) BONDED STRUCTURE INCLUDING A CONDUCTIVE BONDING LAYER AND LOW-TEMPERATURE METHOD OF FORMING A BONDED STRUCTURE

(71) Applicant: Electroninks Incorporated, Austin, TX (US)

(72) Inventors: Steven Brett Walker, Austin, TX (US); Melburne C. LeMieux, San Jose, CA (US)

(21) Appl. No.: 14/687,056

(22) Filed: Apr. 15, 2015

Related U.S. Application Data
(60) Provisional application No. 61/980,816, filed on Apr. 17, 2014.

(51) Int. Cl. B23K 20/02; B23K 35/22; H01B 1/22; B23K 35/02

(52) U.S. Cl. CPC B23K 20/023; B23K 35/025; B23K 35/22; H01B 1/22

(57) ABSTRACT

A bonded structure formed by a low-temperature bonding method comprises a first substrate bonded to a second substrate by a conductive layer comprising a metal. The conductive layer includes a first interfacial portion adjacent to the first substrate, a second interfacial portion adjacent to the second substrate, and a central portion between the first and second interfacial portions. The first and second interfacial portions comprise an interfacial conductivity of from about 1% to about 20% of a bulk conductivity of the metal, and the central portion comprises from greater than 20% to about 80% of the bulk conductivity of the metal. The bonded structure comprises a bond strength of from about 10 lbf to about 200 lbf.

### RELATED APPLICATION

The present patent document claims the benefit of priority under 35 U.S.C. §119(e) to U.S. Provisional Patent Application Ser. No. 61/980,816, filed on Apr. 17, 2014, which is hereby incorporated by reference in its entirety.

### TECHNICAL FIELD

The present disclosure is related generally to bonding of electronic and/or mechanical components, and more particularly to bonding substrates together with a conductive bonding layer at low temperatures.

### BACKGROUND

Printed electronics offer an attractive alternative to conventional technologies by enabling the creation of large-area, flexible devices at low cost. At the heart of printed electronic devices are conductive inks that may be printed on a substrate using a number of different deposition techniques. There are a plethora of applications for high-conductivity materials with fine-scale features in modern electronics such as solar cell electrodes, flexible displays, radio frequency identification tags, antennas, and many more.

In efforts to make these high-technology devices increasingly affordable, the substrates used may have relatively little temperature resilience and may require low processing temperatures to maintain integrity. The processing challenges are compounded when such substrates must be bonded together, since elevated temperatures may be required to obtain a strong bond. Even if heat-resistant substrates, such as ceramics, are used, obtaining a reliable conductive bonding layer may be difficult due to thermal mismatch between the ceramic and the conductive bonding layer. To prevent cracking during thermal processing, it may be necessary to use undesirably thick ceramic substrates. Furthermore, the temperature requirements of conventional bonding methods may make the use of polymer and/or paper substrates impossible.

### BRIEF SUMMARY

A new low-temperature bonding method and a bonded structure including a conductive bonding layer are described herein.

The bonded structure comprises a first substrate bonded to a second substrate by a conductive layer comprising a metal. The conductive layer includes a first interfacial portion adjacent to the first substrate, a second interfacial portion adjacent to the second substrate, and a central portion between the first and second interfacial portions. The first and second interfacial portions comprise an interfacial conductivity of from about 1% to about 20% of a bulk conductivity of the metal, and the central portion comprises from greater than 20% to about 80% of the bulk conductivity of the metal. The bonded structure comprises a bond strength of from about 10 lbf to about 200 lbf.

The low-temperature bonding method comprises applying a reactive ink composition comprising a metal precursor and an adhesion promoter to a first substrate and to a second substrate. The reactive ink composition is heated to a temperature of about 120° C. or less to form a first conductive film on the first substrate and a second conductive film on the second substrate. Each of the first and second conductive films comprises a composite of a metal and a glassy phase formed by decomposition of the metal precursor and the adhesion promoter, respectively. A conductive paste comprising metal particles in a solvent is applied to at least one of the first and second conductive films. The first and second substrates are brought together to form an assembly where the conductive paste is disposed between the first and second conductive films, and the assembly is heated at a temperature of about 200° C. or less. Consequently, a bonded structure comprising the first and second substrates and a conductive layer in between is formed.

The terms “comprising,” “including,” “containing” and “having” are used interchangeably throughout this disclosure as open-ended terms to refer to the recited elements (or steps) without excluding unrecited elements (or steps).

### BRIEF DESCRIPTION OF THE DRAWINGS

FIGS. 1A-1D are cross-sectional schematics that show exemplary steps of the low-temperature bonding method.

FIG. 2 shows a cross-sectional schematic of an exemplary bonded structure.

### DETAILED DESCRIPTION

A new, low-temperature bonding method for ceramic and other substrates used in electronic applications has been developed. Due to the low processing temperatures of the new method, much thinner ceramic substrates and heat sensitive materials, such as polymers and paper, may be bonded together. The resulting bonded assemblies may exhibit a high shear bond strength and include a highly conductive bonding layer.

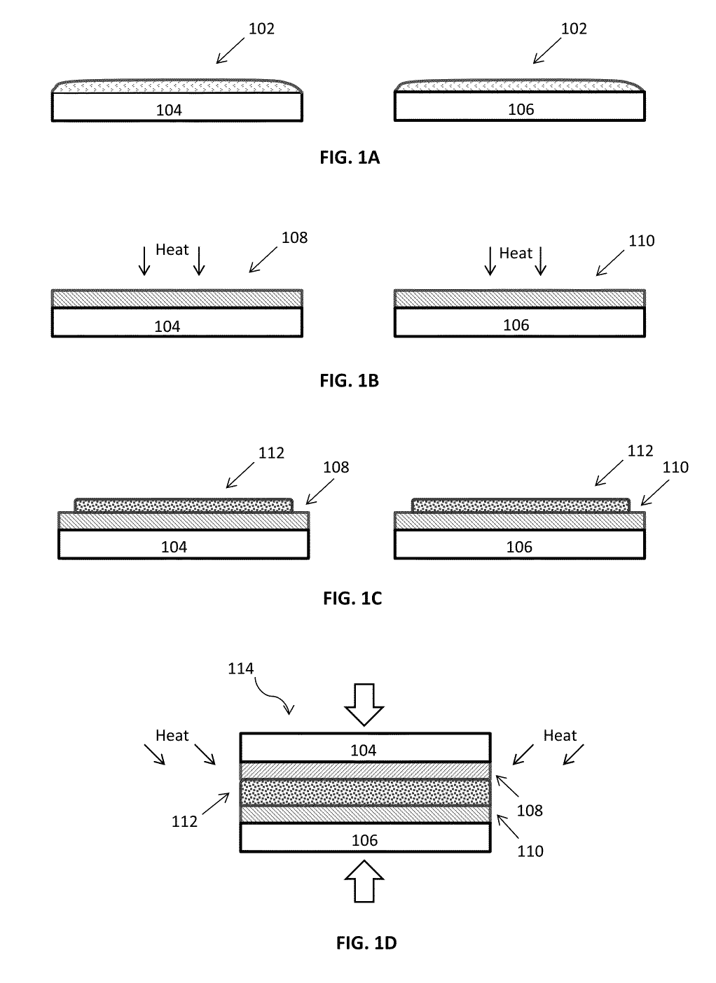

Referring to FIG. 1A, the low-temperature method of bonding substrates together comprises applying a reactive ink composition 102 including a metal precursor and an adhesion promoter to a first substrate 104 and to a second substrate 106.

Referring to FIG. 1B, the reactive ink composition is heated to a temperature of about 120° C. or less, causing the metal precursor to decompose to a metal (or metal phase) and the adhesion promoter to decompose to a glass phase. Consequently, a first conductive film 108 comprising a composite of the metal and the glass phase is formed on the first substrate 104, and a second conductive film 110 comprising a composite of the metal and glass phase is formed on the second substrate 106. The presence of the glass phase is important for ensuring that the first and second conductive films are highly adherent to their respective substrates, and the presence of the metal allows the films to exhibit a conductivity of from about 1% to about 20% of the bulk metal conductivity.

Referring to FIG. 1C, a conductive paste 112 comprising metal particles in a solvent is applied to (deposited on) at least one of the first and second conductive films 108,110. This conductive paste 112, along with the first and second conductive films 108,110, ultimately forms a bonding layer between the first and second substrates 104,106 as described below. The conductive paste 112 may be deposited in a layer that partially or completely covers the first conductive film and/or the second conductive film 108,110. It may be advantageous to deposit the conductive paste 112 on both of the first and second conductive films 108,110, as shown in FIG. 1C.

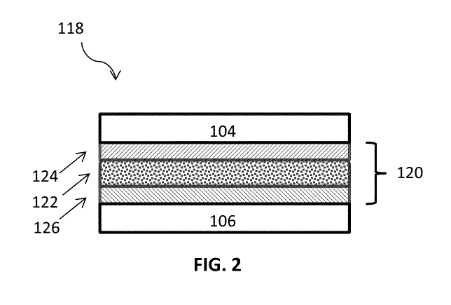

Referring to FIG. 10, after depositing the conductive paste, the first and second substrates 104,106 may be brought together to form an assembly 114 in which the conductive paste 112 is disposed between the first and second conductive films 108,110. An applied force less than the compressive strength of each of the first and second substrates 104,106 may be applied to the assembly 114 to press the first and substrates 104,106 together. With or without the applied force, the assembly 114 is annealed or heated at a temperature of about 200° C. or less, and a bonded structure 118 comprising the first and second substrates 104,106 and including a conductive layer 120 in between is formed, as shown in FIG. 2. The bonded structure 118 produced by the low temperature processing method may exhibit a shear bond strength of from about 10 lbf to about 200 lbf.

The first and second substrates employed in the bonding methods may comprise a ceramic, polymer, metal, semiconductor, paper or another material. For example, suitable ceramics may include alumina, aluminum nitride, barium strontium titanate, barium tantalate, barium titanate, boron nitride, calcium titanate, beryllia, zinc niobate, lead zirconate titanate, lead magnesium niobate, lead zinc niobate, lithium niobate, magnesium aluminum silicate, magnesium silicate, magnesium titanate, niobium oxide, porcelain, silica, strontium titanate, tantalum oxide, titania, titanium nitride, and/or zirconia. Suitable semiconductors may include, for example, silicon, germanium, gallium arsenide, gallium nitride, gallium phosphide, indium phosphide, indium-tin oxide, and/or tin oxide. Paper substrates may include paper, cardstock, cardboard, or other cellulose-based materials. The first and second substrates may comprise the same or different materials. In some embodiments, the first and second substrates may have an average surface roughness of at least about 1 micron or comprise some amount of porosity (e.g., about 1 vol. % or greater) to facilitate adhesion to the first and second conductive films.

Advantageously, the first and second substrates may have a reduced thickness compared to traditionally used ceramic substrates, which are typically several millimeters (e.g., 4-5 mm) in thickness to ensure sufficient mechanical integrity during processing at high temperatures. For example, enabled by the low temperature processing method, the first and second substrates may be about 3 mm or less in thickness, about 2 mm or less in thickness, about 1 mm or less in thickness, or about 500 microns or less in thickness.

The metal precursor of the reactive ink composition may comprise a silver precursor, a nickel precursor, a copper precursor, and/or a tin precursor. When heated to a low temperature, typically about 120° C. or less (e.g., from about 80° C. to about 120° C.), the metal precursor may decompose to form the respective metal. The metal precursor may comprise a silver precursor as described for example in International Application No. PCT/US2012/071034 entitled “Ink Composition for Making a Conductive Silver Structure,” filed on Dec. 20, 2012, and which is hereby incorporated by reference in its entirety. The metal precursor may also or alternatively include a metal precursor as described in U.S. Provisional Patent Application No. 61/980,870, entitled “Reactive Metal Complexes and their Alloys,” filed on Apr. 17, 2014, as described in U.S. Provisional Patent Application No. 61/980,863, entitled “Method of Creating a Conductive Structure from a Silver Precursor,” filed on Apr. 17, 2014, as described in U.S. Provisional Patent Application No. 61/980,933, entitled “Ink Composition,” filed on Apr. 17, 2014, or U.S. Provisional Patent Application No. 61/980,951, entitled “Solid Ink Composition,” filed on Apr. 17, 2014, all of which are hereby incorporated by reference in their entirety.

The adhesion promoter of the reactive ink composition may comprise a hydrolytic complex that may include an organic functional group, such as a hydrolytic silane with an amino functional group. Suitable hydrolytic silanes may include alkoxysilanes, chlorosilanes, and/or acetoxysilanes. Suitable organic functional groups may include amino functional groups, mercapto functional groups, diamine functional groups, and sulfonate functional groups. Specific examples of hydrolytic silanes with organic functional groups include but are not limited to: 3-aminopropyltriethoxysilane, 3-aminopropyltrimethoxysilane, 3-mercaptopropyltriethoxysilane, and 3-mercaptopropyltrimethoxysilane. When heated to a low temperature, typically about 120° C. or less (e.g., from 80° C. to about 120° C.), the adhesion promoter may decompose to form a glassy phase comprising a hydrolytic silane decomposition product (e.g., a silicon oxide or silicate) and an organic functional group. The adhesion promoter may also function as a chelator or dispersant for the metal precursor in the reactive ink composition prior to heating. Other suitable hydrolytic complexes may include titanium (IV) methoxide, titanium (IV) butoxide, tin (IV) compounds, tin (II) compounds, and zirconium (IV) compounds.

In order to minimize porosity in the conductive layer after bonding, it is beneficial for the conductive paste to contain a high solids loading, e.g., a large weight fraction and/or volume fraction of metal particles. For example, the metal particles may have a concentration in the conductive paste of at least about 60 wt. %, at least about 70 wt. %, at least about 80 wt. %, at least about 85 wt. %, at least about 90 wt. %, or at least about 95 wt. %, and up to about 99 wt. %. The metal particles may include metal flakes, which have a morphology well suited for achieving a high packing density. In addition to or alternatively, metal particles of other morphologies (e.g., spherical or acicular) may be used. The metal particles may have at least one dimension smaller than 100 nm. For example, metal flakes of less than 100 nm in thickness with a microscale diameter or length/width may be suitable for the conductive paste. Metal nanoparticles having a diameter or width of less than 100 nm may also or alternatively be used.

The metal particles may comprise one or more metals, such as transition metals, metalloids and/or rare earth metals. Suitable metals may be selected from the group consisting of: Al, Sc, Ti, V, Cr, Mn, Fe, Co, Ni, Cu, Y, Zr, Nb, Mo, Tc, Ru, Rh, Pd, Ag, In, Sn, Sb, Hf, Ta, W, Re, Os, Ir, Pt, and Au. Preferred metals include silver (Ag), nickel (Ni), copper (Cu), and/or tin (Sn). Typically, the metal formed by decomposition of the metal precursor (to form the first and second conductive films) and the metal employed for the metal particles in the conductive paste is the same metal.

The conductive paste may include any of a number of aqueous and nonaqueous solvents including water, alcohols (such as methanol, ethanol, 1-propanol and 2-propanol), glycol ethers, ketones, and esters. The solvent may be formulated to include a metal precursor that decomposes to form a metal upon heating to aid in eliminating porosity from the bonding layer during heating. For example, the solvent may include from about 1 wt. % to about 10 wt. % of a metal precursor (e.g., about 5 wt. %). In a preferred embodiment, the metal precursor is a silver precursor (for example, as set forth in International Application No. PCT/US2012/071034 entitled “Ink Composition for Making a Conductive Silver Structure,” filed Dec. 20, 2012) and thus the metal is silver. The metal formed by the decomposition may be the same metal making up the metal particles, as set forth above.

The force applied to the first and second substrates to enhance the bonding process may range from about 10 psi to about 300 psi, or from about 50 psi to about 150 psi. The force may be applied by clamping, rolling or calendering, for example.

Referring to FIG. 2, the bonded structure 118 may comprise a first substrate 104 bonded to a second substrate 106 by a conductive layer 120 comprising a metal. The conductive layer includes a first interfacial portion 124 adjacent to the first substrate 104, a second interfacial portion 126 adjacent to the second substrate 106, and a central portion 122 between the first and second interfacial portions 124,126. The first and second interfacial portions 124,126 comprise an interfacial conductivity of from about 1% to about 20% of a bulk conductivity of the metal and the central portion 122 comprises from greater than 20% to about 80% of the bulk conductivity of the metal. The bonded structure 118 may exhibit a bond strength of from about 10 lbf to about 300 lbf.

The first and second interfacial portions comprise a composite of the metal (a metal phase) and a glassy phase. The glassy phase may comprise a hydrolytic silane decomposition product and an organic functional group as set forth above. The metal may comprise one or more metals as set forth above, including but not limited to silver, nickel, copper, and/or tin. In a preferred embodiment, the metal is silver and the glassy phase is an amino silicate formed by the decomposition of 3-aminopropyltriethoxysilane. The presence of the glassy phase, typically in an amount of about 1% to 50% by weight of deposited metal, may enhance the adhesion of the first and second interfacial portions to their respective substrates, and the presence of the metal allows the first and second interfacial portions to exhibit a conductivity of from about 1% to about 20% of the bulk conductivity of the metal. The conductivity may be at least about 10% to about 20% of the bulk conductivity of the metal. Typically, the first and second interfacial portions each have a thickness of less than 1 micron (i.e., a submicron thickness). For example, the thickness may be from about 200 nm to about 500 nm, or from about 300 nm to about 400 nm.

The central portion consists essentially of the metal. That is, the central portion may include only the metal and any incidental impurities. The central portion is engineered to be highly electrically conductive with a conductivity preferably at least about 30% of the bulk metal conductivity and a low porosity to facilitate good bond strength. For example, the conductivity of the central portion may be at least about 40%, at least about 50%, at least about 60%, or at least about 70% of the bulk conductivity of the metal, and up to about 80%, up to about 90%, or up to about 99% of the bulk conductivity of the metal. The central portion typically has a thickness of from about 1 micron to about 10 microns, or from about 1 micron to about 5 microns.

The shear bond strength achieved from the bonded structure may be at least about 50 lbf, at least about 100 lbf, at least about 150 lbf, or at least about 200 lbf, and may be as high as about 300 lbf.

### EXAMPLE

A silver precursor, such as a silver formate, silver neodecanoate, silver carbamate, silver isobutyrate, or silver ethanolamine complex, is mixed with 5% by volume 3-aminopropyl triethoxysilane (APTES) to create a reactive ink composition. The ink composition is applied to a ceramic substrate, and annealed at 100° C. Upon annealing, the silver precursor decomposes to silver metal and the APTES to an amino silicate, and a strongly adherent film is formed. The process is repeated on a second ceramic substrate. A small amount of silver paste containing greater than 80 wt. % silver is applied to the film on each substrate. The substrates are compressed together and heated to 150° C., sintering the silver paste and resulting in solid bonding between the two ceramic substrates.

Although the present invention has been described in considerable detail with reference to certain embodiments thereof, other embodiments are possible without departing from the present invention. The spirit and scope of the appended claims should not be limited, therefore, to the description of the preferred embodiments contained herein. All embodiments that come within the meaning of the claims, either literally or by equivalence, are intended to be embraced therein.

Furthermore, the advantages described above are not necessarily the only advantages of the invention, and it is not necessarily expected that all of the described advantages will be achieved with every embodiment of the invention.

1. A bonded structure comprising:
a first substrate bonded to a second substrate by a conductive layer comprising a metal, the conductive layer including:
a first interfacial portion adjacent to the first substrate;
a second interfacial portion adjacent to the second substrate, and
a central portion between the first and second interfacial portions,
wherein the first and second interfacial portions comprise an interfacial conductivity of from about 1% to about 20% of a bulk conductivity of the metal and the central portion comprises from greater than 20% to about 80% of the bulk conductivity of the metal, and
wherein the bonded structure comprises a bond strength of from about 10 lbf to about 200 lbf.

2. The bonded structure of claim 1, wherein the first and second interfacial portions comprise a composite of the metal and a glassy phase.

3. The bonded structure of claim 1, wherein the glassy phase comprises a hydrolytic silane decomposition product and an organic functional group.

4. The bonded structure of claim 3, wherein the organic functional group is selected from an amino group and a mercapto group.

5. The bonded structure of claim 1, wherein the central portion consists essentially of the metal.

6. The bonded structure of claim 1, wherein the metal is selected from the group consisting of: silver, nickel, copper, and tin.

7. The bonded structure of claim 1, wherein each of the interfacial portions comprises a thickness of from about 200 nm to about 500 nm.

8. The bonded structure of claim 1, wherein the central portion comprises a thickness of from about 1 micron to about 10 microns.

9. A low-temperature method of forming a bonded structure, the method comprising:
applying a reactive ink composition comprising a metal precursor and an adhesion promoter to a first substrate and to a second substrate;
heating the reactive ink composition to a temperature of about 120° C. or less to form a first conductive film on the first substrate and a second conductive film on the second substrate, each of the first and second conductive films comprising a composite of a metal and a glassy phase formed by decomposition of the metal precursor and the adhesion promoter, respectively;
applying a conductive paste comprising metal particles in a solvent to at least one of the first and second conductive films;
bringing the first and second substrates together to form an assembly where the conductive paste is disposed between the first and second conductive films;
heating the assembly at a temperature of about 200° C. or less to form a bonded structure comprising the first and second substrates and a conductive layer in between.

10. The method of claim 9, wherein the bonded assembly has a shear bond strength of from about 10 lbf to about 200 lbf.

11. The method of claim 9, wherein, during the heating, the assembly is pressed together with an applied force no greater than a compressive strength of the first and second substrates.

12. The method of claim 11, wherein the applied force is from about 10 psi to about 300 psi.

13. The method of claim 9, wherein the metal precursor is selected from the group consisting of: silver precursor, a nickel precursor, a copper precursor, and a tin precursor.

14. The method of claim 9, wherein the adhesion promoter comprises a hydrolytic complex.

15. The method of claim 14, wherein the hydrolytic complex comprises a hydrolytic silane selected from the group consisting of: an alkoxysilane, a chlorosilane, and/or an acetoxysilane.

16. The method of claim 9, wherein the solvent includes a metal precursor.

17. The method of claim 9, wherein the metal particles have a concentration in the conductive paste of at least about 80 wt. %.

18. The method of claim 17, wherein the concentration is at least about 90 wt. %.

19. The method of claim 9, wherein the metal particles comprise metal flakes.

20. The method of claim 9, wherein at least one dimension of the metal particles is 100 nm or less.
